(19) United States
(12) Patent Application Publication
(10) Pub. No.: US 2014/0169234 A1
(43) Pub. Date: Jun. 19, 2014

(54) Systems and Methods for Interference Avoidance, Channel Sounding, and Other Signaling for Multi-User Full Duplex Transmission

(71) Applicant: FUTUREWEI TECHNOLOGIES, INC., (unknown)

(72) Inventors: Peiying Zhu, Kanata (CA); Wen Tong, Ottawa (CA); Jianglei Ma, Ottawa (CA)

(73) Assignee: FUTUREWEI TECHNOLOGIES, INC., Plano, US (US)

(21) Appl. No.: 13/802,230

(22) Filed: Mar. 13, 2013

Related U.S. Application Data
(60) Provisional application No. 61/737,627, filed on Dec. 14, 2012.

(51) Int. Cl. H04W 72/08

(52) U.S. Cl. CPC H04W 72/082
USPC 370/277

(57) ABSTRACT

System and method embodiments are provided for transmission and reception scheduling for wireless devices in a multi-user full duplex transmission environment. The embodiments enable interference avoidance between neighboring wireless devices. The system and method also enable channel sounding. In an embodiment, a method for scheduling transmissions in a multi-user wireless system includes determining, by a transmission point, neighboring wireless devices for each of a plurality of wireless devices located within a coverage area of the transmission point and determining, by the transmission point, a transmission schedules for respective ones of the plurality of wireless devices according to the neighboring information of the devices such that each respective wireless device is scheduled to transmit data over different time-frequency resources than those in which neighboring wireless devices of the respective wireless device are scheduled to receive data.

### CROSS-REFERENCE TO RELATED APPLICATIONS

The present application claims the benefit of U.S. Provisional Patent Application No. 61/737,627 filed Dec. 14, 2012 and entitled “System and Method for Interference Avoidance for Multi-User Full Duplex Transmission,” which is incorporated herein by reference as if reproduced in its entirety.

### TECHNICAL FIELD

The present invention relates to systems and methods for wireless communications, and, in particular embodiments, to systems and methods for interference avoidance for multi-user full duplex transmission and to channel sounding using full duplex transmission.

### BACKGROUND

New technologies such as coordinated multi-point (CoMP), interference alignment (IA), dirty paper coding (DPC), massive multiple-input multiple-output (MIMO), etc. may be some of the keys to capacity enhancement for wireless systems. However, all of the benefits provided by these technologies may not be realized due to the requirements for precise channel knowledge. For a frequency division duplex (FDD) system, various channel feedback schemes have been proposed. However, the overhead, accuracy, and feedback delay are still major roadblocks. Recently, interest in full duplex transmission technology has surged in the quest to increase spectrum efficiency. Several practical systems have demonstrated that a full duplex transmission system may cancel self-interference from the transmitter to its own receiver for low power transmission.

### SUMMARY OF THE INVENTION

In accordance with an embodiment, a method for scheduling transmissions in a multi-user wireless system includes determining, by a transmission point, neighboring wireless devices for each of a plurality of wireless devices located within a coverage area of the transmission point and determining, by the transmission point, a transmission schedules for respective ones of the plurality of wireless devices according to the neighboring information of the devices such that each respective wireless device is scheduled to transmit data over different time-frequency resources than those in which neighboring wireless devices of the respective wireless device are scheduled to receive data.

In accordance with another embodiment, a network component configured for scheduling transmissions for a plurality of wireless devices in a multi-user full duplex transmission wireless system is provided. The network component includes a processor and a computer readable storage medium storing programming for execution by the processor. The programming includes instructions to determine neighboring wireless devices for each of a plurality of wireless devices located within a coverage area of a base transceiver station (BTS). The programming also includes instructions to determine transmission schedules for respective ones of the plurality of wireless devices such that each respective wireless device is scheduled to transmit data over different time-frequency resources than those in which neighboring wireless devices of the respective wireless device are scheduled to receive data.

In accordance with another embodiment, a method for scheduling transmissions for a plurality of wireless devices in a multi-user full duplex transmission wireless system is provided. The method comprises determining neighbor wireless devices for a wireless device wirelessly coupled to a base transceiver station (BTS), scheduling transmission from the wireless device to the BTS on a channel when none of the neighbor wireless devices to the wireless device are scheduled to receive data from the BTS on the channel, and scheduling data transmission to the wireless device from the BTS on the channel when none of the neighbor wireless devices are scheduled to transmit to the BTS on the channel.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a network for communicating data;

FIGS. 2A-2C illustrate an embodiment system for BTS scheduling of UEs transmission and reception times;

FIGS. 3A-3C illustrate an embodiment system for multiple BTS scheduling of UEs transmission and reception times;

FIGS. 4A-4C illustrate an embodiment system for BTS scheduling of UEs for UE to BTS channel sounding;

FIGS. 5A-5C illustrate an embodiment system for multiple BTS scheduling of UE to BTS channel sounding;

FIG. 6 illustrates a flowchart of an embodiment method for scheduling of UEs; and

FIG. 7 is a processing system that can be used to implement various embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Despite the demonstrated practical systems for self-interference correction in full duplex transmission, the question remains as to whether full duplex transmission can achieve very high self-interference cancellation when receiving data, especially in cellular systems. In addition, it is still costly for a terminal to perform full duplex transmission. Furthermore, in a multi-user access environment, even if self-interference can be cancelled, there may also be interferences from neighboring user equipment (UEs), which could impact a UE's data reception significantly. On the other hand, device-to-device self-discovery is being investigated in both WiFi and cellular standard bodies. It is expected that the position information of UEs may be readily available either via GPS or via positioning services. In various embodiments, the UE may monitor its neighbor's interference level.

In a multi-user access environment, even if a full duplex transmission can reduce or cancel self-interference, it may still be subject to other users' interference. This interference could potentially block the data reception. Various embodiments provide a scheme to avoid interference from other UEs via scheduling based on UE neighboring list information for full duplex transmission. Various embodiments further provide a scheme to obtain channel information based on UE location, scheduling information, device to device discovery and base transceiver station (BTS) full duplex transmission (FDT) capability with relaxed self-interference suppression requirements. In various embodiments, the UE neighboring list may also include the indication of interference level. The BTS can use this additional information to aid the UE scheduling. The UE neighboring list may also be treated as a logical neighboring list, where a neighbor of a UE is defined as the one whose interference to this UE is above a certain level. The BTS can also create this logical neighboring list based on the physical neighboring list and use the logical list for scheduling.

Benefits of an embodiment may include the enablement of multi-user access for full duplex transmission, which may increase overall capacity up to about two times. Other benefits of an embodiment may include the enablement of CoMP, cloud radio access network (CRAN), IA and massive MIMO for FDD without additional channel state feedback overhead and for TDD without calibration, thus increasing overall capacity.

In an embodiment, assuming that both the BTS and UE are capable of FDT, the BTS forms a neighbor list of UEs via device discovery, and/or UE location discovery, and/or GPS, and/or using UE mobility information and prediction, and UE interference measurement. The BTS schedules a UE's data transmission on downlink (DL) frequency at the resources not used by its neighbors to avoid interference on data reception of other UEs. In an alternative embodiment, the BTS can divide UEs into multiple groups based on a reference signal received power (RSRP) or path loss measurement, and schedule UEs from different groups to avoid interference.

In another embodiment, assuming that the BTS is capable of FDT, whether the UE is or is not, the BTS forms a neighbor list of UEs via device discovery, and/or UE location discovery, and/or GPS, and/or using mobility information and prediction, and UE interference measurement. The BTS schedules UEs sounding on DL frequency to avoid interference on data reception of other UEs. As used herein, the terms sounding or channel sounding may be used interchangeably and may include methods for determining channel state information and/or the quality of a wireless channel. The main purpose of sounding is to determine the channel state information. Sounding is a mechanism in which a pilot sequence is sent by a UE and the BTS determines the channel response based on the received pilots. For an orthogonal frequency-division multiplexing (OFDM) system, the full channel state information can be obtained by interpolating the channels based on measured channels on pilots. Multiple UE's pilot can be sent simultaneously via frequency, code, and time division. An OFDM is a method of encoding digital data on multiple carrier frequencies (often called multiple sub-carriers). For an OFDM system, multiple subcarriers in frequency and time domain can be assigned to a UE to transmit data, where those subcarriers are referred as resources. The quality of the wireless channel may be determined based on the signal strength, the amount of interference, bandwidth, throughput, or other indicia of channel quality. The quality of the wireless channel may also be determined based on a combination of factors.

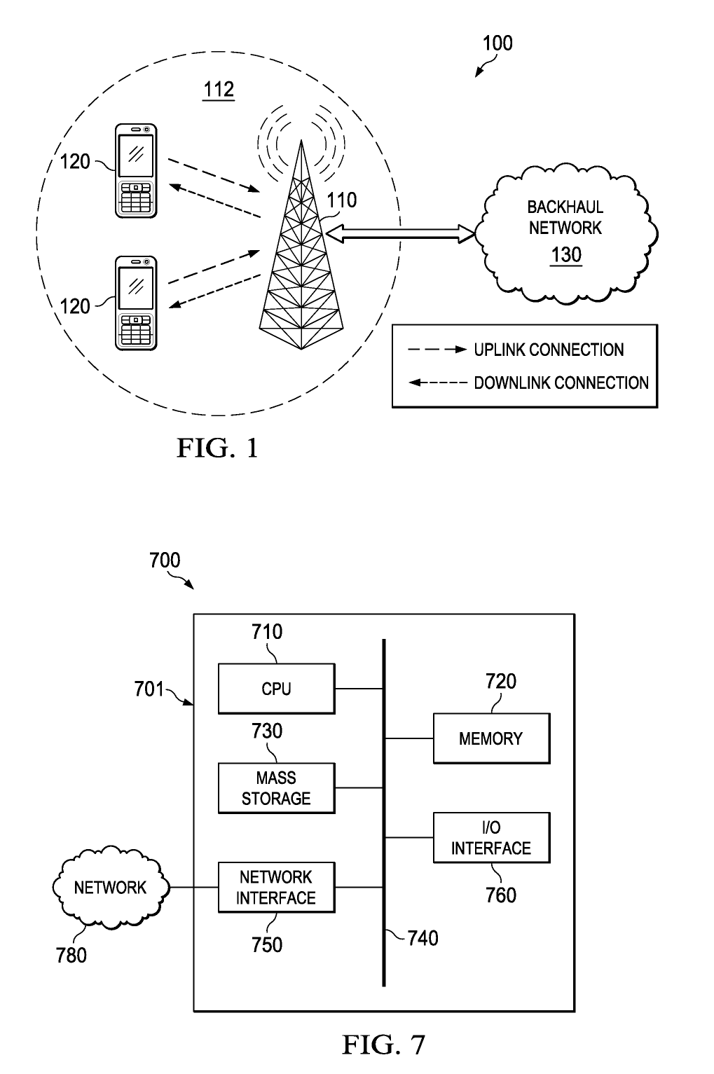

FIG. 1 illustrates a network 100 for communicating data. The network 100 includes an access point (AP) 110 having a coverage area 112, a plurality of user equipment (UEs) 120, and a backhaul network 130. As used herein, the term AP may also be referred to as a transmission point (TP), a BTS, or an enhanced base station (eNB), and the different terms may be used interchangeably throughout this disclosure. The AP 110 may comprise any component capable of providing wireless access by, inter alia, establishing uplink (dashed line) and/or downlink (dotted line) connections with the UEs 120, such as a BTS, an eNB, a femtocell, and other wirelessly enabled devices. The UEs 120 may comprise any component capable of establishing a wireless connection with the AP 110. The backhaul network 130 may be any component or collection of components that allow data to be exchanged between the AP 110 and a remote end (not shown in FIG. 1). In some embodiments, the network 100 may comprise various other wireless devices, such as relays, femtocells, etc.

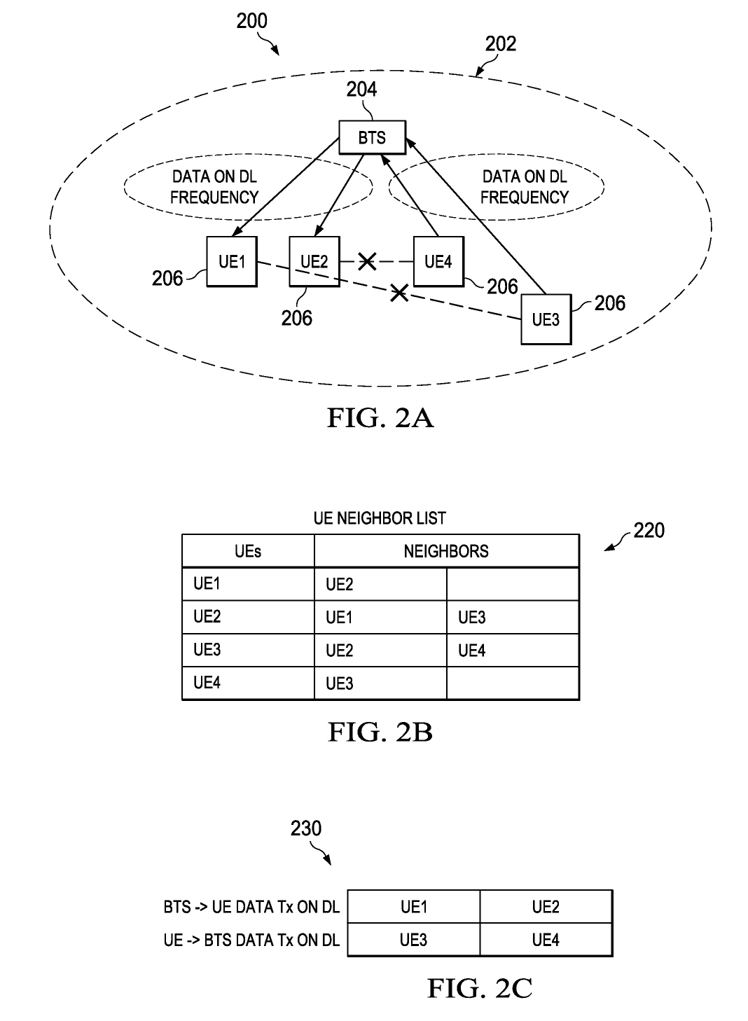

FIGS. 2A-2C illustrate an embodiment system 200 for BTS scheduling of UEs transmission and reception interval over the same channel resources. The system 200 may be similar to the network 100 illustrated in FIG. 1. As illustrated in FIG. 2A, the system 200 may include a BTS 204 and a plurality of UEs 206. The BTS 204 may have a coverage area 202 as illustrated. The BTS 204 may be any device that is capable of establishing uplinks (ULs) and downlinks (DLs) with the UEs 206. The DLs refer to the transmission links from the BTS 204 to the UEs 206 and the ULs refer to the transmission links from the UEs 206 to the BTS 204.

The BTS 204 may utilize full duplex allowing the BTS 204 to send and receive data on the same channel at the same time. As used herein the channel refers to the frequency carrier. The DL and the UL in a full duplex system may use the same channel. The BTS 204 may include a processing system capable of receiving or determining neighbors of the UEs 206 and determining a schedule for the UEs 206 to transmit and receive based on the identified neighbors. The UEs 206 may also be referred to as wireless devices. The UEs 206 may be any device capable of establishing a wireless connection with the BTS 204. Examples of wireless devices include mobile phones, smart phones, table computers, laptop computers, and the like. One, several, or all of the UEs 206 may be capable of full duplex transmission and reception. Alternatively, none of the UEs 206 may be capable of full duplex transmission and reception. Thus, an embodiment allows the BTS 204 to work in full duplex, while the UE 206 works in full or half duplex. As used herein, a device operating in full duplex mode may transmit and receive on the same channel simultaneously. As used herein, in a time division duplex (TDD) system, a device operating in half duplex mode may both transmit and receive on the same channel, but may not do so at the same time (e.g., the device may transmit on the channel and then receive on the same channel at a later time). In a frequency division duplex (FDD) system, the UE transmits and receives simultaneously, but on different frequency channels. The dashed lines with an “X” indicate that the UEs 206 connected by the dashed lines are not neighbors of one another.

FIG. 2B illustrates a UE 206 neighbor list 220 for the UEs 206 identified in FIG. 2A. The neighbors of UE1 may be UE2. The neighbors of UE2 may be UE1 and UE3. The neighbors of UE3 may be UE2 and UE4. The neighbors of UE4 may be UE3. The neighbor list for each UE 206 may be determined by the UE 206 and transmitted to the BTS 204 from the UE 206. The BTS 204 may use the neighbor list for each UE 206 to compile a master neighbor list for all the UEs 206 in the BTS's 204 coverage area 202. Each UE 206 may determine its neighbors by measuring a signal strength of other UEs 206. Some beacons/pilots may be inserted or dedicated for such measurement purposes. The signal from each UE 206 may identify, provide an identifier for, or otherwise provide an identification of the UE 206. If the signal strength of a UE 206 exceeds a threshold, then the UE 206 may be considered a neighbor. UEs 206 whose signal strength at a specific UE 206 does not exceed a threshold may not be considered neighbors since their signals may not be sufficiently strong to cause significant interference at the measuring UE 206. The signals received by the UEs 206 from other UEs 206 may include an identifier. The definition of a neighbor or neighboring wireless device may vary depending on implementation and, in an embodiment, may be a wireless device that is capable of or is causing interference with another wireless device.

Alternatively, the BTS 204 may determine the location(s) of the UEs 206 (e.g., using a global positioning system (GPS) or other location determining method) and determine a neighbor list for each UE 206 based on their proximity to other UEs 206. In addition to the position information, the BTS 204 may also determine the type of each UE 206 and use this information in determining a neighbor list for each UE 206 since different types of UEs 206 may have different signal strength characteristics. The BTS 204 may also use the neighbor lists of UEs 206 that provide the information to the BTS and may determine the neighbor list for other UEs 206 that may be incapable of determining a neighbor list independently. The combination of the UE 206 determined neighbors and the BTS 204 determined neighbors may be used to create the master list of UE 206 neighbors.

The neighbor lists may change dynamically with time since UEs 206 may move within the coverage area 202, may move outside the coverage area 202, or may be powered down (e.g., turned off). Additionally, other UEs 206 may be powered on (e.g., turned on) or may enter the coverage area 202. Thus, the UEs 206 that may be considered neighbors of each other at one time may not be neighbors at another time. Since the neighbor lists may change dynamically with time, the schedule determined by the BTS 204 may change with time. The master neighbor list and the schedule may be updated periodically or when the BTS 204 determines that one or more of the UEs 206 neighbors has changed.

From this master neighbor list, the BTS 204 may determine a transmission and reception schedule 230 for the UEs 206. The transmission and reception schedule may be determined such that no neighbor to a UE 206 may transmit using the same resources as the UE 206 when the UE 206 is using those resources to receive data, thereby mitigating interference effects experienced by the receiving UE 206 caused by other UEs 206 in the coverage area 202.

As illustrated in FIG. 2C, any non-UE1 neighbors, i.e., UE3 and UE4, can transmit data using the same resources as UE1 while UE1 receives data from the BTS 204 (e.g., at the same time on the same sub-carrier as UE1). Similarly, any non-UE2 neighbors, i.e., UE4, may transmit data using the same resources as UE2 (e.g., at the same time on the same sub-carrier as UE2). Conversely, when UE3 receives data from the BTS 204, UE 1 may transmit data to the BTS 204 on the same resources. However, UE2 and UE4 may not transmit data using the same resources since they are neighbors to UE 3. It should be noted that any UE 206 that is capable of full duplex transmission may receive and transmit data simultaneously since the UE 206 may be aware of its self-interference and may utilize well known methods for cancelling or mitigating the self-interference.

Although described with reference to four UEs 206, system 200 may include any number of UEs 206 and is not limited to four. Additionally, a UE 206 may have more than two neighbors, may only have one neighbor, or may have no neighbors.

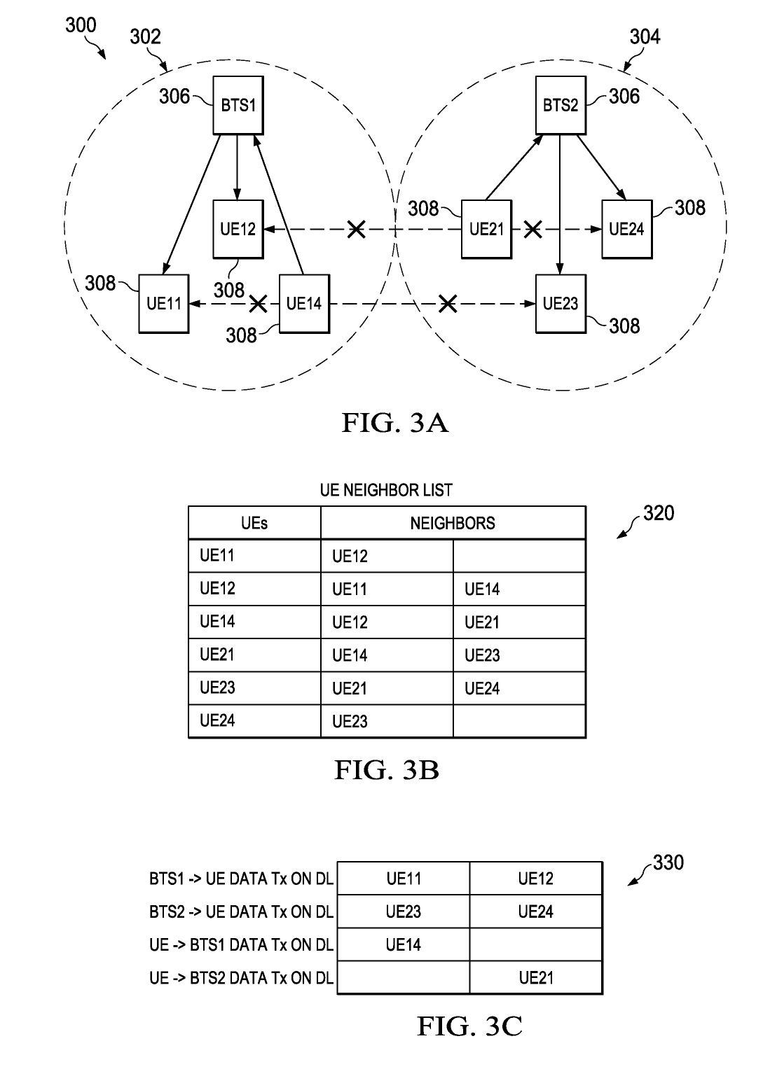

FIGS. 3A-3C illustrate an embodiment system 300 for multiple BTS scheduling of UEs transmission and reception times. The system 300 may be similar to the system 200 illustrated in FIG. 2A except for the inclusion of multiple BTSs instead of a single BTS. As illustrated in FIG. 3A, the system 300 may include multiple BTS's 306 and a plurality of UEs 308. Each BTS 306 may have its own coverage area 302, 304. As illustrated, BTS1 has a coverage area 302 which may include UE11, UE12, and UE14. BTS2 may have a coverage area 304 which may include UE21, UE23, and UE24. Each BTS 306 may be similar to BTS 204 in FIG. 2A. The UEs 308 may be similar to the UEs 206 in FIG. 2A. The BTS's 306 may determine the neighbors for the plurality of UEs 308 as described above with reference to FIGS. 2A-2C.

UE 14 and UE 21 may be on the edge of their respective coverage areas 302, 304. As such, UE14 and UE 21 may be neighbors to one another and may potentially cause interference in one another even though they communicate with different BTSs 306. Therefore, BTS1 and BTS2 may coordinate their transmission and reception schedules such that UE14 and UE21 are not transmitting data while the other one is receiving data. In an embodiment, a master neighbor list may be created that includes UE neighbors for both coverage areas 302, 304. BTS1 may determine a transmission and reception schedule for all the UEs 308 in both coverage areas 302 and 304. The schedule may be transmitted to the BTS2 through a backhaul network (not shown) such as backhaul network 130 depicted in FIG. 1. Both the BTS1 and the BTS2 may use the schedule to prevent neighbor UEs 308 in both the UEs own coverage area 302, 304 and in neighboring coverage areas 302, 304 from transmitting when a neighbor UE 308 is receiving data from the BTS 306. The BTS1 and the BTS2 may alternate creating the schedules or periodically or occasionally switch which one creates the schedules. Alternatively, both BTS's 306 may create the schedules using the same algorithm to computer the schedules based on the same neighbor list, thereby ensuring that both BTS's 306 execute the same schedule. In another embodiment, a central controller (not shown in FIG. 3A) may take care of the scheduling for both BTS1 and BTS2 and forward the schedule to both BTS1 and BTS2.

FIG. 3B illustrates a UE 308 neighbor list 320 for the UEs 308 identified in FIG. 3A. As shown, the neighbors for UE11 may be UE12, the neighbors for UE12 may be UE11 and UE14, the neighbors for UE14 may be UE12 and UE21, the neighbors for UE21 may be UE 14 and UE 23, the neighbors for UE 23 may be UE21 and UE 24, and the neighbors for UE24 may be UE23.

As illustrated in FIG. 3C, a partial UE transmission and reception schedule 330 is shown based on the neighbor list of FIG. 3B. The partial UE transmission and reception schedule 330 does not show the schedule for all of the UEs for all times. As shown, UE11 may receive data from BTS1, UE23 may receive data from BTS2, and UE14 may transmit data to the BTS1 at the same time. UE12, UE24, and UE21 may not transmit at the time this time. At another time, UE12 may receive data from BTS1, UE24 may receive data from BTS2, and UE 21 may transmit data to BTS2 at the same time, but UE11, UE23, and UE14 may not transmit at this time. In this manner, no UEs 308 are transmitting while their neighbor UEs 308 are receiving data from the BTS 306, thereby eliminating a source of interference for UE2 308 that is receiving data.

Alternatively, rather than sharing scheduling information with each other, each BTS 306 may reserve a region for cell edge UE's sounding. Also, in an embodiment, both BTS1 and BTS2 may receive sounding signal from an edge UE 308 that is near the edge of both coverage area 302 and coverage area 304 (e.g., from UE 14)

Although system 300 is described with reference to two BTS's 306 and to six UEs 308, the number of BTS's may be greater than two and the number of UEs may be different in some embodiments. Additionally, a UE 308 may have more than two neighbors or may have no neighbors.

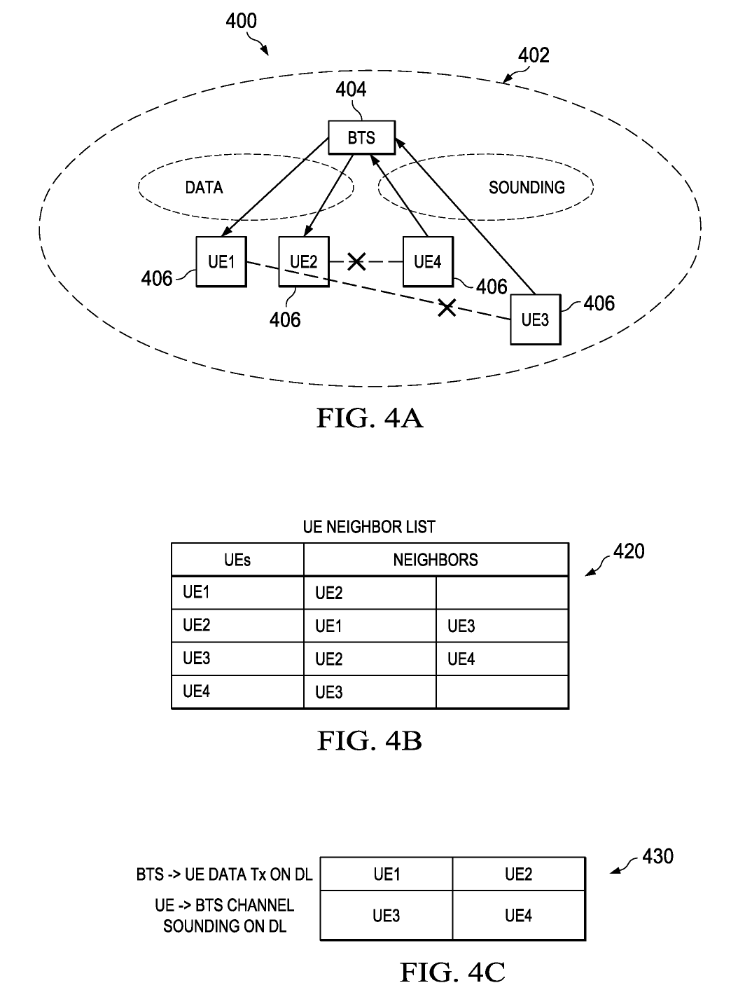

FIGS. 4A-4C illustrate another embodiment system 400 for BTS scheduling of UEs. The system 400 may be substantially similar to system 200 depicted in FIG. 2A. The system 200 may comprise a BTS 404 and a plurality of UEs 406. The BTS 404 may have a coverage area 402. The BTS 404 may be substantially similar to BTS 204 depicted in FIG. 2A and the UEs 406 may be substantially similar to the UEs 206 depicted in FIG. 2A. The BTS 406 may receive or determine a master neighbor list for the UEs 406 in its coverage area 402. The BTS 406 may determine the neighbors for the UEs 406 in any number of manners such as those described above with reference to FIGS. 2A-2C. From this neighbor list, the BTS 404 may schedule BTS to UE data transmissions on the DL and schedule the non-neighboring UEs 406 to perform channel sounding on the same DL at the same time. Neighboring UEs 406 may not perform channel sounding while one of their neighbor UEs 406 is receiving a BTS to UE data transmission on the DL.

The BTS 404 may schedule the BTS to UE data transmission on DL first, and then schedule UE to BTS channel sounding on DL for non-neighboring UEs to avoid interfering BTS to DL data transmission. Alternatively, the BS could schedule UE to BTS channel sounding on DL first, then schedule BTS to UE data transmission on DL. For high mobility UEs, the BTS could reserve dedicated resources so that there is no sounding on those resources or can update a neighbor list based on mobility information and prediction. In an embodiment, a high mobility UE's sounding channel may be transmitted in a UL frequency. For a cell edge UE, if BTSs 404 do not coordinate the scheduling, the dedicated resources could also be used for BTS to UE data transmission on DL.

FIG. 4B illustrates a UE neighbor list 420 for the UEs identified in FIG. 4A. As shown, the neighbors of UE1 may be UE2, the neighbors of UE2 may be UE1 and UE3, the neighbors of UE3 may be UE2 and UE4, and the neighbors of UE4 may be UE3. A partial schedule 430 for channel sounding and BTS to UE data transmission is shown in FIG. 4C. Channel sounding for any non-UE1 neighbors, e.g., UE3 and UE4, may be performed when BTS to UE data transmission is occurring for UE1. However, no neighbors of UE1, e.g., UE2 may perform channel sounding while UE1 is receiving data from the BTS 404. As depicted, BTS to UE data transmission on the DL may be performed for UE1 while UE3 (a non-neighboring UE to UE1) performs UE to BTS channel sounding on the DL. BTS to UE data transmission on the DL may be performed for UE2 while UE4 (a non-neighboring UE to UE2) performs UE to BTS channel sounding on the DL. UEs 406 that are performing channel sounding on the DL may also transmit data on the UL at the same time using carrier aggregation (CA).

Although described with reference to four UEs 406, system 400 may include any number of UEs 406 and is not limited to four. Additionally, a UE 406 may have more than two neighbors, may only have one neighbor, or may have no neighbors.

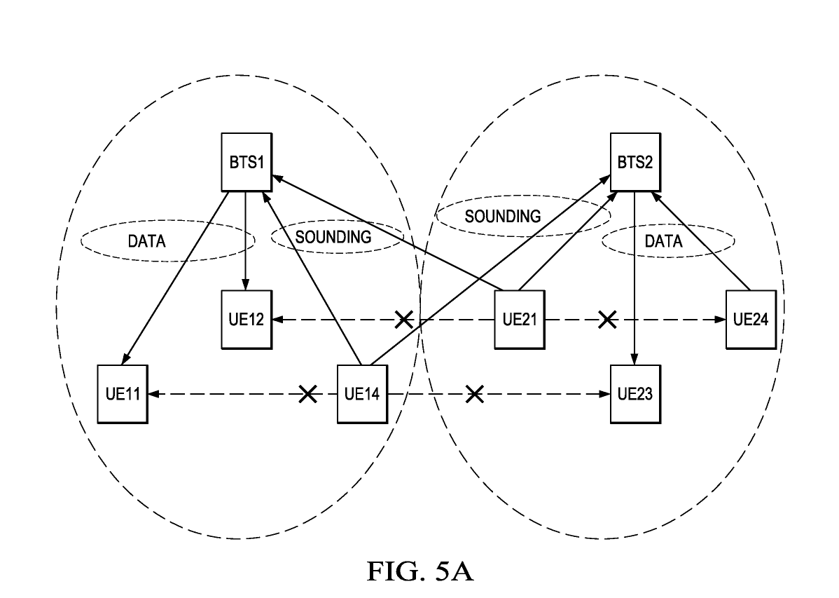

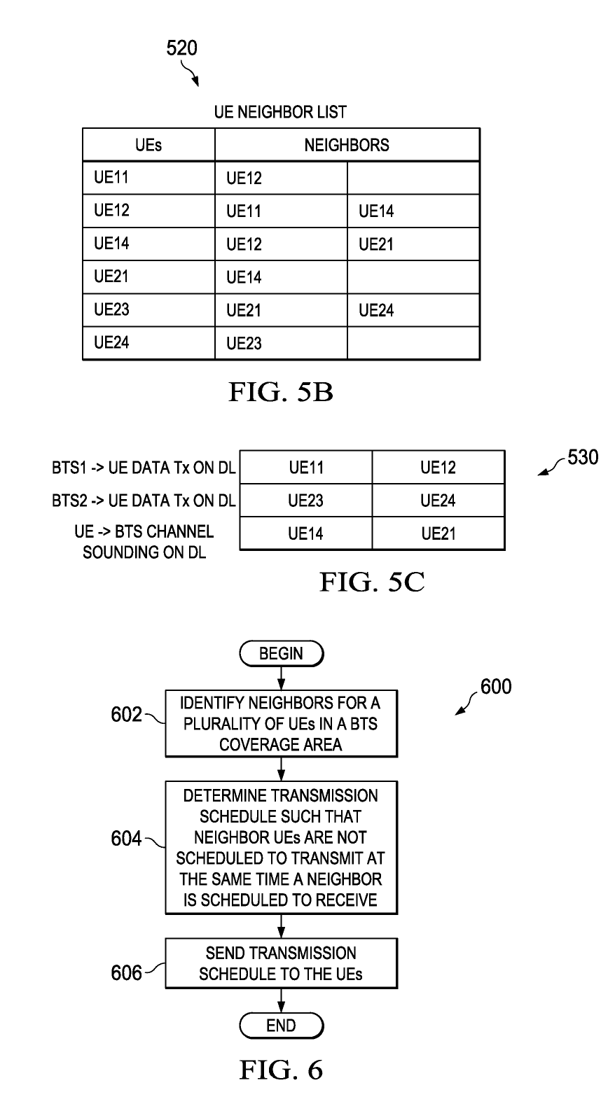

FIGS. 5A-5C illustrate an embodiment system 500 for multiple BTS scheduling of UE to BTS sounding. System 500 may be substantially similar to system 300 depicted in FIG. 3. System 500 may comprise multiple BTS's 506 and multiple UEs 510. Each BST 506 may have a corresponding coverage area 502. The BTS 506 may determine neighboring devices in a similar manner to those described above with reference to FIGS. 2A-2C. In a manner similar to system 300, the BTS 506 in system 500 may coordinate the scheduling of UE to BTS sounding with other BTS's 506 such that UEs 510 on the edge of a coverage area 502, 504 that are near a UE in a different coverage area 502, 504 will be scheduled such that when they perform sounding on the DL, their sounding transmissions will not interfere with a BTS to UE data transmission in a neighboring UE 502 that may be in a different coverage area 502, 504 corresponding to a different BTS 506.

FIG. 5B illustrates a UE neighbor list 520 for the UEs identified in FIG. 5A. As shown, the neighbors of UE11 may be UE12, the neighbors of UE12 may be UE11 and UE14, the neighbors of UE14 may be UE12 and UE21, the neighbors of UE21 may be UE 14, the neighbors of UE23 may be UE 21 and UE 24, and the neighbors of UE24 may be UE23. A partial schedule 530 for channel sounding and BTS to UE data transmission is shown in FIG. 5C. Channel sounding for any non-UE11 neighbors, e.g., UE14, UE21, UE23, and UE24, may be performed when BTS to UE data transmission is occurring for UE11. However, no neighbors of UE11, e.g., UE12 may perform channel sounding while UE11 is receiving data from the BTS 1 506. As depicted, BTS to UE data transmission on the DL may be performed for UE11 and UE23 while UE14 (a non-neighboring UE to UE11 and UE23) performs UE to BTS channel sounding on the DL. BTS to UE data transmission on the DL may be performed for UE12 and UE24 while UE21 (a non-neighboring UE to UE12 and UE24) performs UE to BTS channel sounding on the DL.

Although system 500 is described with reference to two BTS's 506 and to six UEs 510, the number of BTS's may be greater than two and the number of UEs may be different in some embodiments. Additionally, in an embodiment, a UE 510 may have more than two neighbors or may have no neighbors.

Embodiments are not limited to UE to BTS channel sounding on DL, for example, embodiments may include UE to BTS data and control signaling transmission on DL frequency carrier, including low data rate spreading, low data rate traffic, highly protected control channels, etc. In an embodiment, if the UE sends low rate data on DL, it may be preferable to spread data (for example via code division multiple access (CDMA), or spreading over OFDM sub-carriers) so that the self-interference cancellation can be relaxed. Similarly, if highly protected control channel information is transmitted from UE on DL, self-interference cancellation can also be relaxed. Embodiments also may be used for full duplex transmission on UL. Moreover, for a TDD system, embodiments may include creation of a customized DL/UL configuration. In addition, there are a variety of ways to signal the data transmission and sounding. Also, channel sounding may be scheduled periodically or occasionally at aperiodic intervals. Furthermore, although described in terms of channels, the disclosed systems and methods may be applied to any time-frequency resource for communicating data between a BTS and a wireless device.

FIG. 6 illustrates a flowchart of an embodiment method 600 for scheduling of UEs. The method 600 may be implemented, for example, in a BTS such as BTS 110 in FIG. 1, BTS 204 in FIG. 2A, BTS's 306 in FIG. 3A, BTS 404 in FIG. 4A, or BTS's 506 in FIG. 5A. The method 600 may begin at 602 where the BTS may identify the neighbors for a plurality of UEs in the BTS coverage area. In an embodiment, some or all of the UEs in the BTS's coverage area may report their neighbors to the BTS. The BTS may also identify the neighbors for UEs that are in other BTS's coverage areas. At block 604, the BTS may determine a transmission schedule for the plurality of UEs such that a UE is not scheduled to transmit when a neighboring UE is scheduled to receive a BTS to UE transmission data. A UE may perform UE to BTS transmissions during a time when a BTS to UE data transmission is scheduled for a non-neighboring UE. UE to BTS transmissions may include UE to BTS channel sounding, UE to BTS data transmission, and UE to BTS data and control signaling transmission on DL, including low data rate spreading, highly protected control channels, etc. At block 606, the BTS may transmit the transmission schedules to the UEs, after which, the method 600 may end.

FIG. 7 is a block diagram of a processing system 700 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 700 may comprise a processing unit 701 equipped with one or more input/output devices, such as a speaker, microphone, mouse, touchscreen, keypad, keyboard, printer, display, and the like. The processing unit 701 may include a central processing unit (CPU) 710, memory 720, a mass storage device 730, a network interface 750, and an I/O interface 760 connected to a bus 740.

The bus 740 may be one or more of any type of several bus architectures including a memory bus or memory controller, a peripheral bus, video bus, or the like. The CPU 710 may comprise any type of electronic data processor. The memory 720 may comprise any type of system memory such as static random access memory (SRAM), dynamic random access memory (DRAM), synchronous DRAM (SDRAM), read-only memory (ROM), a combination thereof, or the like. In an embodiment, the memory 720 may include ROM for use at boot-up, and DRAM for program and data storage for use while executing programs.

The mass storage device 730 may comprise any type of storage device configured to store data, programs, and other information and to make the data, programs, and other information accessible via the bus 740. The mass storage device 730 may comprise, for example, one or more of a solid state drive, hard disk drive, a magnetic disk drive, an optical disk drive, or the like.

The I/O interface 760 may provide interfaces to couple external input and output devices to the processing unit 701. The I/O interface 760 may include a video adapter. Examples of input and output devices may include a display coupled to the video adapter and a mouse/keyboard/printer coupled to the I/O interface. Other devices may be coupled to the processing unit 701, and additional or fewer interface cards may be utilized. For example, a serial interface such as Universal Serial Bus (USB) (not shown) may be used to provide an interface for a printer.

The processing unit 701 may also include one or more network interfaces 750, which may comprise wired links, such as an Ethernet cable or the like, and/or wireless links to access nodes or different networks. The network interface 701 allows the processing unit to communicate with remote units via the networks 780. For example, the network interface 750 may provide wireless communication via one or more transmitters/transmit antennas and one or more receivers/receive antennas. In an embodiment, the processing unit 701 is coupled to a local-area network or a wide-area network for data processing and communications with remote devices, such as other processing units, the Internet, remote storage facilities, or the like.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method for scheduling transmissions in a multi-user wireless system, the method comprising:
determining, by a transmission point, neighboring wireless devices for each of a plurality of wireless devices located within a coverage area of the transmission point; and
determining, by the transmission point, a transmission schedules for respective ones of the plurality of wireless devices according to the neighboring information of the devices such that each respective wireless device is scheduled to transmit data over different time-frequency resources than those in which neighboring wireless devices of the respective wireless device are scheduled to receive data.

2. The method of claim 1 further comprising scheduling a wireless device to transmit data to the transmission point on a first time-frequency resource at a same time that a non-neighbor wireless device is scheduled to receive data from the transmission point on the first time-frequency resource.

3. The method of claim 1 further comprising scheduling a wireless device to transmit one of channel sounding, control signaling, and low data rate traffic on a first time-frequency resource at a same time that a non-neighbor wireless device is scheduled to receive data from the transmission point on the first time-frequency resource.

4. The method of claim 1 wherein determining neighboring wireless devices for each of the plurality of wireless devices comprises receiving an identification of neighboring wireless devices from at least one of the plurality of wireless devices.

5. The method of claim 1, wherein determining neighboring wireless devices for each of the plurality of wireless devices comprises determining locations of the plurality of wireless devices.

6. The method of claim 1, further comprising coordinating schedules with an other BTS.

7. The method of claim 6, wherein coordinating schedules with another BTS comprises determining neighbors for wireless devices in the coverage area for the BTS and in a coverage area for the other BTS, wherein at least one wireless device in the coverage area for the BTS is a neighbor to at least one wireless device in the coverage area for the other BTS.

8. The method of claim 6, wherein coordinating schedules with an other BTS comprises determining a schedule for the wireless devices in the coverage area for the BTS and for the wireless devices in a coverage are for the other BTS and transmitting the schedule to the other BTS.

9. The method of claim 6, wherein coordinating schedules with an other BTS comprises receiving a schedule from the other BTS.

10. The method of claim 1, wherein dedicated resources are allocated to wireless devices on an edge of the coverage area for the transmission point.

11. The method of claim 1, wherein the transmission point operates in full duplex mode.

12. A network component configured for scheduling transmissions for a plurality of wireless devices in a multi-user full duplex transmission wireless system comprising:
a processor; and
a computer readable storage medium storing programming for execution by the processor, the programming including instructions to:
determine neighboring wireless devices for each of the plurality of wireless devices located within a coverage area of a base transceiver station (BTS); and
determine transmission schedules for respective ones of the plurality of wireless devices such that each respective wireless device is scheduled to transmit data over different time-frequency resources than those in which neighboring wireless devices of the respective wireless device are scheduled to receive data.

13. The network component of claim 12 wherein the programming further includes instructions to schedule a wireless device to transmit data to the BTS on a first time-frequency resource at a same time that a non-neighbor wireless device is scheduled to receive data from the BTS on the first time-frequency resource.

14. The network component of claim 12 wherein the programming further includes instructions to schedule a wireless device to transmit one of channel sounding, control signaling, and low data rate traffic on a first time-frequency resource at a same time that a non-neighbor wireless device is scheduled to receive data from the BTS on the first time-frequency resource.

15. The network component of claim 12 wherein the instructions to determine neighboring wireless devices for each of the plurality of wireless devices comprises instructions to receive an identification of neighboring wireless devices from at least one of the plurality of wireless devices.

16. The network component of claim 12, wherein the instructions to determine neighboring wireless devices for each of the plurality of wireless devices comprises instructions to determine the location of the plurality of wireless devices.

17. The network component of claim 12, wherein the programming further includes instructions to coordinate schedules with another BTS.

18. The network component of claim 17, wherein the instructions to coordinate schedules with an other BTS comprise instructions to determine neighbors for wireless devices in the coverage area for the BTS and in a coverage area for the other BTS, wherein at least one wireless device in the coverage area for the BTS is a neighbor to at least one wireless device in the coverage area for the other BTS.

19. The network component of claim 17, wherein the instructions to coordinate schedules with an other BTS comprise instructions to determine a schedule for the wireless devices in the coverage area for the BTS and for the wireless devices in a coverage are for the other BTS and transmitting the schedule to the other BTS.

20. The network component of claim 17, wherein the instructions to coordinate schedules with an other BTS comprise instructions to receive a schedule from the other BTS.

21. The network component of claim 12, wherein the programming further includes instructions to allocate dedicated resources to wireless devices on an edge of the coverage area for the BTS.

22. The network component of claim 12, wherein the BTS is configured to operate in full duplex mode.

23. A method for scheduling transmissions for a plurality of wireless devices in a multi-user full duplex transmission wireless system, the method comprising:
determining, by a base transceiver station (BTS), neighbor wireless devices for a first wireless device wirelessly coupled to the BTS;
scheduling, by the BTS, transmission from the first wireless device to the BTS on a channel when none of the neighbor wireless devices to the first wireless device are scheduled to receive data from the BTS on the channel; and
scheduling, by the BTS, data transmission to the first wireless device from the BTS on the channel when none of the neighbor wireless devices are scheduled to transmit to the BTS on the channel.

24. The method of claim 23, wherein the transmission from the first wireless device to the BTS comprises channel sounding.

25. The method of claim 23, wherein the transmission from the first wireless device to the BTS comprises control signaling.

26. The method of claim 23, wherein at least one of the neighbor devices is in a different coverage area from the first wireless device.

27. The method of claim 23, wherein the first wireless device is located at an edge of a coverage area for the BTS and wherein the transmission comprises channel sounding to the BTS and to a different BTS.

28. The method of claim 23, further comprising sending a transmission schedule for the first wireless device to another BTS.
